(19) United States
(12) Patent Application Publication
(10) Pub. No.: US 2026/0177012 A1
(43) Pub. Date: Jun. 25, 2026

(54) AERONAUTICAL PROPULSION SYSTEM WITH IMPROVED PROPULSION EFFICIENCY

(71) Applicant: SAFRAN AIRCRAFT ENGINES, Paris (FR)

(72) Inventor: Didier René André ESCURE, MOISSY-CRAMAYEL (FR)

(73) Assignee: SAFRAN AIRCRAFT ENGINES, Paris (FR)

(21) Appl. No.: 19/128,432

(22) PCT Filed: Nov. 8, 2023
(86) PCT No.: PCT/FR2023/051750

§ 371 Date: May 8, 2025

(30) Foreign Application Priority Data
Nov. 9, 2022 (FR) FR2211674

(51) Int. Cl. F02C 7/36

(52) U.S. Cl. CPC F02C 7/36

(57) ABSTRACT

A propulsion system includes a drive turbine connected to a drive shaft movable in rotation about an axis of rotation, a fan section including a fan rotor connected to a fan shaft, and a reduction structure coupling the drive shaft and the fan shaft in order to drive the fan shaft at a rotation speed lower than the rotation speed of the drive shaft. In the propulsion system, a rotation speed of the drive shaft complies with a formula defining a relationship among the rotation speed of the drive shaft, an inlet temperature of the drive turbine when the propulsion system is stationary in a take-off rating in a standard atmosphere and at sea level, and an inlet section of the drive turbine, in square meters.

### TECHNICAL FIELD

The present application generally relates to the field of propulsion systems, and more particularly to propulsion systems comprising a ducted or unducted fan and having a propulsion efficiency and a high fan efficiency.

### BACKGROUND

A propulsion system generally includes, from upstream to downstream in the direction of gas flow, a fan section, a compressor section that may comprise a low-pressure compressor and a high-pressure compressor, a combustion chamber and a turbine section that may comprise in particular a high-pressure turbine and a low-pressure turbine. The high-pressure compressor is driven in rotation by the high-pressure turbine via a high-pressure shaft. The fan and, where applicable, the low-pressure compressor are driven in rotation by the low-pressure turbine via a low-pressure shaft.

Technological research efforts have already led to very significant improvements in the environmental performance of aircrafts. The Applicant takes into account the factors that have an impact on all design and development phases to obtain less energy-intensive, more environmentally friendly aeronautical components and products, the integration and use of which in civil aviation have moderate environmental consequences, with the aim of improving the energy efficiency of aircrafts.

Thus, in order to improve the propulsive efficiency of the propulsion system and reduce its specific consumption as well as the noise emitted by the fan section, propulsion systems with a high bypass ratio BPR (corresponding to the ratio between the flow rate of the secondary air stream and the flow rate of the primary air stream) have been proposed. To achieve such bypass ratios, the fan section can be decoupled from the low-pressure turbine, thus making it possible to independently optimize their respective rotation speed. Generally, the decoupling is achieved using a reduction mechanism placed between the upstream end of the low-pressure shaft and a rotor of the fan section. The rotor of the fan section is then driven by the low-pressure shaft via the reduction mechanism at a rotation speed lower than that of the low-pressure shaft.

In order to further improve the overall efficiency of the turbomachine, the current trend is to increase the overall compression ratio of the propulsion system, which corresponds to the ratio between the outlet pressure of the high-pressure compressor and the inlet pressure of the fan. This therefore requires the increase of the compression ratio of the high-pressure compressor and/or of the low-pressure compressor, especially since it is sought at the same time to reduce the compression ratio of the fan to improve its efficiency. One of the possible consequences is that the low-pressure turbine, which drives the fan, is more mechanically loaded, particularly at the bottom of the airfoil. However, any modification to the low-pressure turbine is likely to have an impact on the flow path within the turbine section which can have consequences on its efficiency, the possibilities of integrating the propulsion system into an aircraft or even on the integration of the bearings.

### SUMMARY

One aim of the present application is to optimize the propulsion system in order to increase its efficiency without mechanically and/or thermally overloading the drive turbine of the fan, while taking into account the constraints of integration of the propulsion system.

To this end, according to a first aspect, there is proposed an aeronautical propulsion system comprising:
a drive turbine connected to a drive shaft movable in rotation about an axis of rotation;
a fan section comprising a fan rotor connected to a fan shaft;
a reduction mechanism coupling the drive shaft and the fan shaft in order to drive the fan shaft at a rotation speed lower than the rotation speed of the drive shaft;
   the propulsion system being configured so that a rotation speed of the drive shaft complies with the following formula:

$${N}_{1} \geq \sqrt{\frac{α * {T}_{e} + β}{Se}} \times 1 {0}^{3}$$

where:
N₁ is the rotation speed of the drive shaft when the propulsion system is stationary in take-off rating in a standard atmosphere and at sea level and is expressed in revolutions per minute (rpm);
Tₑ is the inlet temperature of the drive turbine when the propulsion system is stationary in take-off rating in a standard atmosphere and at sea level and is expressed in degrees Celsius (° C.) and is greater than or equal to 700° C.;
Sₑ is an inlet section of the drive turbine (8), in square meters (m²); and

$$α = - 0.056 {( \frac{r e v}{min} )}^{2} \times \frac{{m}^{2}}{° C .} and β = 83.356 {( \frac{r e v}{min} \times m )}^{2}$$

Some preferred but non-limiting characteristics of the propulsion system according to the first aspect are the following, taken individually or in combination:
the propulsion system is further configured so that the drive speed of the drive turbine also complies with the following formula;

$${N}_{1} \leq \sqrt{\frac{55}{{S}_{e}}} \times {10}^{3}$$

the reduction mechanism has a reduction ratio greater than or equal to 2.5, preferably greater than or equal to 3.0 and less than or equal to 11.0;
the drive turbine comprises at least 3 stages and at most 5 stages;
the drive turbine has a hub-to-tip ratio at the inlet greater than 0.75 and less than 0.90;
the drive turbine has a hub-to-tip ratio at the outlet greater than 0.55 and less than 0.75;
the compressor comprises at least two stages and at most four stages;
the propulsion system further comprises a second turbine and a second compressor connected via a second shaft, the second shaft rotating faster than the drive shaft, the second turbine being a two-stage turbine;
the second compressor comprises at least eight stages and at most eleven stages;
a thrust density per blade of the fan rotor of the propulsion system is greater than or equal to 5.0×10⁴ and less than or equal to 17.0×10⁴ N/m² where the thrust density per blade is defined by the following formula:

$$Thrust density = \frac{F N}{n * {D}^{2}} * 100$$

and where:
FN is the thrust generated by the fan rotor and is measured when the propulsion system is stationary in take-off rating in a standard atmosphere and at sea level and is expressed in Newton (N);
n is the number of blades in the fan rotor; and
D is the diameter of the fan rotor, measured in a plane normal to the axis of rotation at an intersection between a tip and a leading edge of the blades of the fan rotor, and is expressed in meters (m);
a power density per blade of the fan rotor is greater than or equal to 3.65×10⁶ and less than or equal to 22.0×10⁶ W/m², where the power density per blade of the fan rotor is defined by the following formula:

$$Power density = \frac{power of the fan}{n * {D}^{2}} * 100$$

and where: the power of the fan corresponds to the power of the fan rotor and is measured when the propulsion system is stationary in take-off rating in a standard atmosphere and at sea level and is expressed in Watts (W);
n is the number of blades in the fan rotor; and
D is the diameter of the fan rotor, measured in a plane normal to the axis of rotation at an intersection between a tip and a leading edge of the blades of the fan rotor, and is expressed in meters (m);
the fan section further has a fan compression ratio, corresponding to a pressure ratio between an outlet of the fan rotor and an inlet of the fan rotor less than or equal to 1.45;
the diameter of the fan rotor is comprised between 80 inches and 185 inches inclusive, preferably between 85 inches and 120 inches inclusive, for example of the order of 90 inches;
the fan section is ducted and a bypass ratio of the propulsion system is greater than or equal to 10, for example comprised between 10 and 35 inclusive, preferably between 10 and 18 inclusive;
the fan section is ducted and a peripheral speed at the tip of the blades of the fan rotor, when the propulsion system is stationary in take-off rating in a standard atmosphere and at sea level, is comprised between 260 m/s and 400 m/s;
the fan section is ducted and a thrust density per blade of the fan rotor of the propulsion system is greater than or equal to 14.0×10⁴ and less than or equal to 17.0×10⁴ N/m² where the thrust density per blade is defined by the following formula:

$$Thrust density = \frac{F N}{n * {D}^{2}} * 100$$

and where: FN is the thrust generated by the fan rotor and is measured when the propulsion system is stationary in take-off rating in a standard atmosphere and at sea level and is expressed in Newton;
n is the number of blades in the fan rotor; and
D is the diameter of the fan rotor, measured in a plane normal to the axis of rotation at an intersection between a tip and a leading edge of the blades of the fan rotor, and is expressed in meters (m);
the fan section is unducted and a bypass ratio of the propulsion system is greater than or equal to 40, for example comprised between 40 and 80 inclusive; and/or
the fan section is unducted and a peripheral speed at the tip of the blades of the fan rotor, when the propulsion system is stationary in take-off rating in a standard atmosphere and at sea level, is comprised between 210 m/s and 260 m/s; and/or
the fan section is unducted and a thrust density per blade of the fan rotor of the propulsion system is greater than or equal to 5.0×10⁴ and less than or equal to 10.0×10⁴ N/m² where the thrust density per blade is defined by the following formula:

$$Thrust density = \frac{F N}{n * {D}^{2}} * 100$$

and where:
FN is the thrust generated by the fan rotor and is measured when the propulsion system is stationary in take-off rating in a standard atmosphere and at sea level and is expressed in Newton;
n is the number of blades in the fan rotor; and
D is the diameter of the fan rotor, measured in a plane normal to the axis of rotation at an intersection between a tip and a leading edge of the blades of the fan rotor, and is expressed in meters (m).

According to a second aspect, the present application proposes an aircraft comprising at least one propulsion system, according to the first aspect, fixed to the aircraft via a mast.

According to a third aspect, the invention proposes a method for dimensioning or manufacturing a propulsion system comprising a reduction mechanism coupling a drive turbine and a fan rotor to drive the fan rotor at a speed lower than a speed of the drive turbine, the drive turbine configured so that a rotation speed of the drive shaft complies with the following formula:

$${N}_{1} \geq \sqrt{\frac{α * {T}_{e} + β}{Se}} \times 1 {0}^{3}$$

where:
N₁ is the rotation speed of the drive shaft when the propulsion system is stationary in take-off rating in a standard atmosphere and at sea level and is expressed in revolutions per minute (rpm);
Tₑ is the inlet temperature of the drive turbine when the propulsion system is stationary in take-off rating in a standard atmosphere and at sea level and is expressed in degrees Celsius (C) and is greater than or equal to 700° C.; Sₑ is an inlet section of the drive turbine (8), in square meters (m²); and

$$α = - 0.056 {( \frac{r e v}{min} )}^{2} \times \frac{{m}^{2}}{° C .} and β = 83.356 {( \frac{r e v}{min} \times m )}^{2}$$

Some preferred but non-limiting aspects of the dimensioning or manufacturing method according to the third aspect are the following, taken individually or in combination:
the fan section is dimensioned such that a thrust density per blade of the fan rotor of the propulsion system is greater than or equal to 5.0×10⁴ and less than or equal to 17.0×10⁴ N/m² where the thrust density per blade is defined by the following formula:

$$Thrust density = \frac{F N}{n * {D}^{2}} * 100$$

and where:
FN is the thrust generated by the fan rotor and is measured when the propulsion system is stationary in take-off rating in a standard atmosphere and at sea level and is expressed in Newton (N);
n is the number of blades in the fan rotor; and
D is the diameter of the fan rotor, measured in a plane normal to the axis of rotation at an intersection between a tip and a leading edge of the blades of the fan rotor, and is expressed in meters (m); and/or
the fan is further dimensioned such that a power density per blade of the fan rotor is greater than or equal to 3.65×10⁶ and less than or equal to 22.0×10⁶ W/m², where the power density per blade of the fan rotor is defined by the following formula:

$$Power density = \frac{power of the fan}{n * {D}^{2}} * 100$$

and where: the power of the fan corresponds to the power of the fan rotor and is measured when the propulsion system is stationary in take-off rating in a standard atmosphere and at sea level and is expressed in Watts (W);
n is the number of blades in the fan rotor; and
D is the diameter of the fan rotor, measured in a plane normal to the axis of rotation at an intersection between a tip and a leading edge of the blades of the fan rotor, and is expressed in meters (m).

According to a fourth aspect, there is proposed a method for manufacturing a propulsion system comprising the following steps:
dimensioning the propulsion system in accordance with the method according to the third aspect; and
manufacturing the propulsion system.

### DESCRIPTION OF THE FIGURES

Other characteristics, aims and advantages will emerge from the following description, which is purely illustrative and non-limiting, and which should be read in relation to the appended drawings, in which:

FIG. 1 is a schematic, partial, sectional view of one example of a propulsion system in accordance with one embodiment, in which the fan section is ducted;

FIG. 2 is a schematic, partial, sectional view of one example of a propulsion system in accordance with a first embodiment, in which the fan section is unducted;

FIG. 3 is a schematic sectional view of one example of a star reduction mechanism;

FIG. 4 is a schematic sectional view of one example of a planetary reduction mechanism;

FIG. 5 is one example of an aircraft that may comprise at least one propulsion system in accordance with one embodiment;

FIG. 6 is a flowchart illustrating examples of steps in a dimensioning or manufacturing method in accordance with one embodiment.

Throughout the figures, similar elements bear identical references.

### DETAILED DESCRIPTION

A propulsion system 1 has a main direction extending along a longitudinal axis X and comprises, from upstream to downstream in the direction of gas flow in the propulsion system 1 when in operation, a fan section 2 and a primary body 3, often called “gas generator”, including a compressor section 4, 5, a combustion chamber 6 and a turbine section 7, 8. The propulsion system 1 is here an aeronautical propulsion system 1 configured to be fixed to an aircraft 100 via a pylon (or mast).

The compressor section 4, 5 comprises a succession of stages each comprising a blade wheel (rotor) 4a, 5a rotating in front of a vane wheel (stator) 4b, 5b. The turbine section 7, 8 also comprises a succession of stages, each comprising a vane wheel (stator) 7a, 8a, behind which a blade wheel (rotor) 7b, 8b rotates.

In the present application, the axial direction corresponds to the direction of the longitudinal axis X, corresponding to the rotation of the gas generator shafts, and a radial direction is a direction perpendicular to this axis X and passing therethrough. Moreover, the circumferential (or lateral or tangential) direction corresponds to a direction perpendicular to the longitudinal axis X and not passing therethrough. Unless otherwise specified, the terms “inner” (respectively, “internal”) and “outer” (respectively, “external”), respectively, are used with reference to a radial direction so that the inner portion or face of an element is closer to the axis X than the outer portion or face of the same element.

In operation, an air stream F entering the propulsion system 1 is divided between a primary air stream F1 and a secondary air stream F2, which circulate from upstream to downstream in the propulsion system 1.

The secondary air stream F2 (also called “bypass air stream”) flows around the primary body 3. The secondary air stream F2 cools the periphery of the primary body 3 and serves to generate most of the thrust provided by the propulsion system 1.

The primary air stream F1 flows in a primary path inside the primary body 3, passing successively through the compressor section 4, 5, the combustion chamber 6 where it is mixed with fuel to serve as an oxidizer, and the turbine section 7, 8. The passage of the primary air stream F1 through the turbine section 7, 8 receiving energy from the combustion chamber 6 causes rotation of the rotor of the turbine section 7, 8, which in turn drives in rotation the rotor of the compressor section 4, 5 as well as a rotor portion 9 of the fan section 2.

In a two-spool propulsion system 1, the compressor section 4, 5 may comprise a low-pressure compressor 4 and a high-pressure compressor 5. The turbine section 7, 8 may comprise a high-pressure turbine 8 and a low-pressure turbine 7. The rotor of the high-pressure compressor 5 is driven in rotation by the rotor of the high-pressure turbine 8 via a high-pressure shaft 10. The rotor of the low-pressure compressor 4 and the rotor portion 9 of the fan section 2 are driven in rotation by the rotor of the low-pressure turbine 7 via a low-pressure shaft 11. Thus, the primary body 3 comprises a high-pressure body comprising the high-pressure compressor 5, the high-pressure turbine 8 and the high-pressure shaft 10, and a low-pressure body comprising the fan section 2, the low-pressure compressor 4, the low-pressure turbine 7 and the low-pressure shaft 11. The rotation speed of the high-pressure body is greater than the rotation speed of the low-pressure body. In a triple-spool propulsion system 1, the turbine section 7, 8 further comprises an intermediate turbine, positioned between the high-pressure turbine 8 and the low-pressure turbine 7 and configured to drive the rotor of the low-pressure compressor 4 via an intermediate shaft. The fan rotor 9 and the rotor of the high-pressure compressor 5 remain driven by the low-pressure shaft 11 and the high-pressure shaft 10, respectively.

The low-pressure shaft 11 is generally housed, over a part of its length, in the high-pressure shaft 10 and is coaxial with the high-pressure shaft 10. The low-pressure shaft 11 and the high-pressure shaft 10 may be co-rotating, that is to say driven in the same direction about the longitudinal axis X. As a variant, the low-pressure shaft 11 and the high-pressure shaft are counter-rotating, that is to say driven in opposite directions about the longitudinal axis X. Where appropriate, the intermediate shaft is housed between the high-pressure shaft 10 and the low-pressure shaft 11. The intermediate shaft and the low-pressure shaft 11 may be co-rotating or counter-rotating.

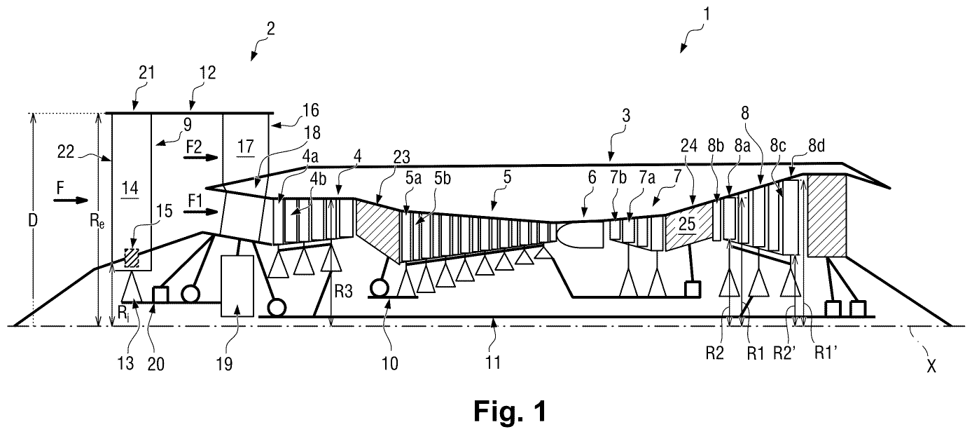

The fan section 2 comprises at least the fan rotor 9 capable of being driven in rotation relative to a stator portion of the propulsion system 1 by the turbine section 7, 8. Each fan rotor 9 comprises a hub 13 and blades 14 extending radially from the hub 13. The blades 14 of each rotor 9 may be fixed relative to the hub 12 or have a variable setting. In this case, the root of the blades 14 i of each rotor 9 is pivotally mounted along a setting axis and is connected to a pitch change mechanism 15 mounted in the propulsion system 1, the setting being adjusted according to the flight phases by a pitch change mechanism 15. The pitch change mechanism 15 is illustrated in broken lines in FIG. 1 to show that this characteristic is optional.

The fan section 2 may further comprise a fan stator 16, or straightener, which comprises vanes 17 mounted on a hub 18 of the fan stator 16 and have the function of straightening the secondary air stream F2 which flows at the outlet of the fan rotor 9. The vanes 17 of the fan stator 18 may be fixed relative to the hub 18 or have a variable setting. In a similar manner to the rotor blades 14, the root of the stator vanes 17 is pivotally mounted along a setting axis X and is connected to a pitch change mechanism 15a, which is generally distinct from that of the fan rotor 9, the setting being adjusted according to the flight phases by the pitch change mechanism.

In order to improve the propulsive efficiency of the propulsion system 1 and to reduce its specific consumption as well as the noise emitted by the fan section 2, the propulsion system 1 has a high bypass ratio. By high bypass ratio, it is meant here a bypass ratio greater than or equal to 10, for example comprised between 10 and 80 inclusive. To calculate the bypass ratio, the mass flow rate of the secondary air stream F2 and the mass flow rate of the primary air stream F1 are measured when the propulsion system 1 is stationary, uninstalled, in take-off rating in a standard atmosphere (as defined by the International Civil Aviation Organization (ICAO) manual, Doc 7488/3, 3^{rd} edition) and at sea level (conditions known as SLS, for Seal Level Standard). It should be noted that, in the present application, the parameters (pressure, flow rate, thrust, speed, etc.) are systematically determined under these conditions. By “uninstalled” it will be meant here that the measurements are performed when the propulsion system 1 is in a test bench (and uninstalled on an aircraft 100), the measurements then being simpler to make. The distances (length, radius, diameter) are however measured at room temperature (around 20° C.) when the propulsion system 1 is cold, that is to say when the propulsion system is stopped from a sufficient period for the parts of the propulsion system to be at room temperature.

The fan rotor 9 is decoupled from the low-pressure shaft 11 using a reduction mechanism 19, placed between an upstream end of the low-pressure shaft 11 and the fan rotor 9, in order to independently optimize their respective rotation speed. In this case, the propulsion system 1 further comprises an additional shaft, called fan shaft 20. The low-pressure shaft 11 connects the low-pressure turbine 7 to an inlet of the reduction mechanism 19 while the fan shaft 20 connects the outlet of the reduction mechanism 19 to the fan rotor 9. The fan rotor 9 is therefore driven by the low-pressure shaft 11 via the reduction mechanism 19 and the fan shaft 20 at a rotation speed lower than the rotation speed of the low-pressure turbine 7.

This decoupling makes it possible to reduce the rotation speed and the pressure ratio of the fan rotor 9 and to increase the power extracted by the low-pressure turbine 7. Indeed, the overall efficiency of the propulsion systems is conditioned to the first order by the propulsive efficiency, which is favorably influenced by minimizing the variation of the kinetic energy of the air at the crossing of the propulsion system 1. In a propulsion system 1 with a high bypass ratio, most of the flow rate generating the propulsive force is constituted by the secondary air stream F2 of the propulsion system 1, the kinetic energy of the secondary air stream F2 being mainly affected by the compression that the secondary air stream F2 undergoes during the crossing of the fan section 2. The propulsive efficiency and the pressure ratio of the fan section 2 are therefore linked: the lower the pressure ratio of the fan section 2, the better the propulsive efficiency. In order to optimize the propulsive efficiency of the propulsion system 1, the pressure ratio of the fan, which corresponds to the ratio between the average outlet pressure of the fan stator 17 (or, in the absence of a stator, of the fan rotor 9) and the average pressure at the inlet of the fan rotor 9, is less than or equal to 1.70, preferably less than or equal to 1.50, for example comprised between 1.05 and 1.45. The average pressures are measured here over the height of the blade 14 (from the surface which radially delimits on the inside the flow path at the inlet of the fan rotor 9 to the tip 21 of the fan blade 14).

The propulsion system 1 is configured to provide a thrust comprised between 18 000 lbf (80 068 N) and 51 000 lbf (22 2411 N), preferably between 20 000 lbf (88,964 N) and 35 000 lbf (15 5688 N).

The fan section 2 may be ducted or unducted. In the case of a ducted fan section 2, the fan section 2 comprises a fan casing 12 and the fan rotor 9 is housed in the fan casing 12.

A ducted fan section 2 comprises a fan rotor 9 extending upstream of a fan stator. The vanes of the fan stator are then generally referred to as outlet guide vanes (OGV) and have a fixed setting relative to the hub of the fan stator. Moreover, the bypass ratio of the propulsion system 1 is preferably greater than or equal to 10, for example comprised between 10 and 35 inclusive, preferably between 10 and 18 inclusive. It should be noted that, when the bypass ratio is greater than or equal to 25, the fan rotor 9 is preferably a variable-setting fan rotor. The peripheral speed at the tip 21 of the blades of the fan rotor 9 may also be comprised between 260 m/s and 400 m/s. The blades 14 of the fan rotor 9 may be fixed or have a variable setting. The fan pressure ratio may then be comprised between 1.20 and 1.45.

In an unducted fan section 2, the fan section 2 is not surrounded by a fan casing. Since the fan section 2 is unducted, the blades 14 of the fan rotor 9 have a variable setting. Propulsion systems comprising at least one unducted fan rotor 9 are also known as “open rotor” or “unducted fan”. The propulsion system 1 may comprise two unducted and counter-rotating fan rotors 9. Such a propulsion system 1 is known as CROR for “Contra-Rotating Open Rotor” or UDF for “Unducted Double Fan”. The fan rotor(s) 9 may be placed at the rear of the primary body 3 so as to be of the pusher type or at the front of the primary body 3 so as to be of the tractive type. As a variant, the propulsion system 1 may comprise a single unducted fan rotor 9 and an unducted fan stator 16 (straightener). Such a propulsion system 1 is known as USF for “Unducted Single Fan”. In the case of a USF-type propulsion system 1, the vanes 17 of the straightener 16 are fixed in rotation relative to the axis of rotation X of the upstream fan rotor 9 and therefore do not undergo centrifugal force. The vanes 17 of the straightener 16 are also variable-setting vanes.

The absence of fairing around the fan section 2 makes it possible to increase the bypass ratio very significantly without the propulsion system 1 being penalized by the mass of the casings or nacelles intended to surround the fan section 2. The bypass ratio of the propulsion system 1 comprising an unducted fan section 2 is thus greater than or equal to 40, for example comprised between 40 and 80 inclusive. The peripheral speed at the tip 21 of the blades 14 of the fan rotor(s) 9 may also be comprised between 210 m/s and 260 m/s. The fan pressure ratio may then be preferably comprised between 1.05 and 1.20.

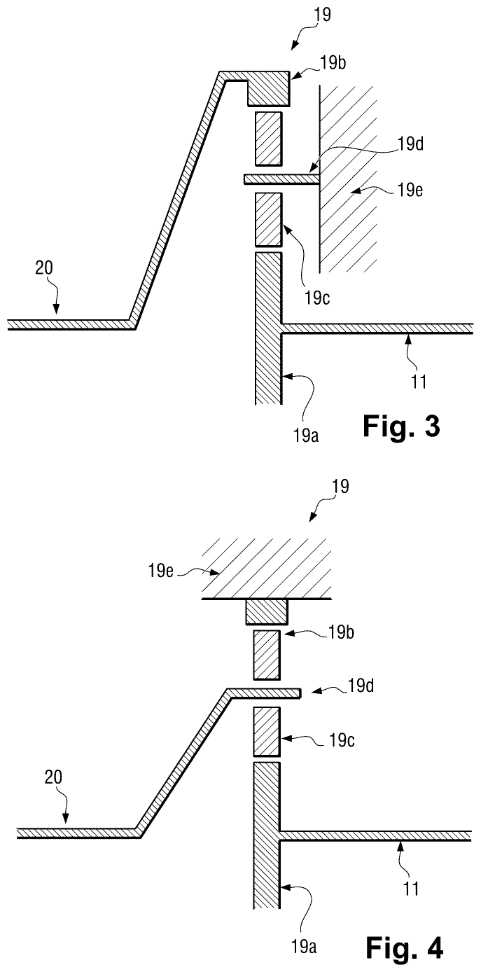

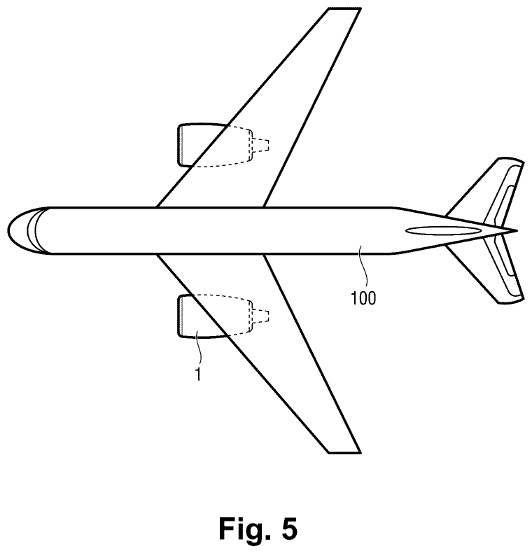

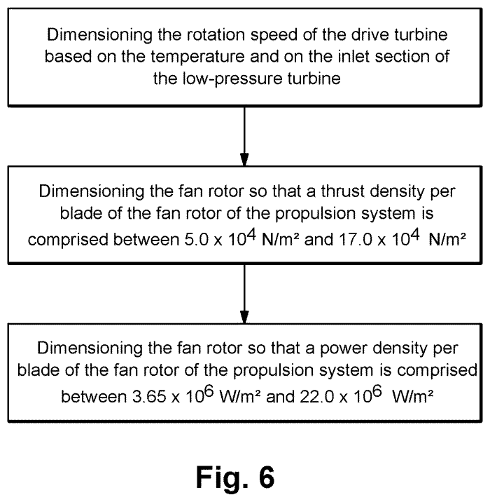

The reduction mechanism 19 may comprise for example a reduction mechanism 19 with a planetary gear train, for example of the “planetary” or “star” type, single-staged or two-staged. According to a first variant, the reduction mechanism 19 may be of the star type (FIG. 3) and comprise a sun gear pinion 19a (inlet of the reduction mechanism 19), centered on an axis of rotation X of the reduction mechanism 19 (generally coincident with the longitudinal axis X) and configured to be driven in rotation by the low-pressure shaft 11, a ring gear 19b (outlet of the reduction mechanism 19) coaxial with the sun gear pinion 19a and configured to drive in rotation the fan shaft 20 about the axis of rotation X, and a series of planet gears 19c circumferentially distributed about the axis of rotation X between the sun gear pinion 19a and the ring gear 19b, each planet gear 19c being meshed internally with the sun gear pinion 19a and externally with the ring gear 19b. The series of planet gears 19c is mounted on a planet gear carrier 19d which is fixed relative to a stator portion 19e of the propulsion system 1, for example relative to a casing of the compressor section 4, 5. According to a second variant, the reduction mechanism 19 can be planetary (FIG. 4), in which case the ring gear 19b is fixedly mounted on the stator portion 19e of the propulsion system 1 and the fan shaft 20 is driven in rotation by the planet gear carrier 19d (which is therefore movable in rotation relative to a stator portion 19e of the propulsion system 1, for example relative to a casing of the compressor section 4, 5).

Regardless of the configuration of the reduction mechanism 19, the diameter of the ring gear 19b and of the planet gear carrier 19d are greater than the diameter of the sun gear pinion 19a, such that the rotation speed of the fan rotor 9 is lower than the rotation speed of the low-pressure shaft 11.

In order to optimize the propulsion system 1 so as to increase its efficiency without mechanically and/or thermally overloading the low-pressure turbine 8, the propulsion system is dimensioned such that a rotation speed of the low-pressure shaft 11 complies with the following formula:

$${N}_{1} \geq \sqrt{\frac{α * {T}_{e} + β}{Se}} \times 1 {0}^{3}$$

where:
N₁ is the rotation speed of the low-pressure shaft 11, in revolutions per minute (rpm);
Tₑ is the inlet temperature of the low-pressure turbine 8, in degrees Celsius (° C.);
Sₑ is the inlet section of the low-pressure turbine 8, in square meters (m²); and

$$α = - 0.056 {( \frac{r e v}{min} )}^{2} \times \frac{{m}^{2}}{° C .} and β = 83.356 {( \frac{r e v}{min} \times m )}^{2}$$

Preferably, the formula (1) applies when Tₑ≥700° C. in order to take into account the creep of the rotor of the low-pressure turbine 7. The inlet temperature of the low-pressure turbine Tₑ can be comprised between 950° C. and 1,230° C. The inlet section of the low-pressure turbine may be comprised between 0.08 m² and 0.35 m².

As previously indicated, all these parameters are determined when the propulsion system 1 is stationary, uninstalled, in take-off rating in a standard atmosphere (as defined by the International Civil Aviation Organization (ICAO) manual, Doc 7488/3, 3^{rd} edition) and at sea level.

The Applicant indeed found that it is necessary to take into account the footprint of the low-pressure turbine 8 to set the rotation speed of the low-pressure shaft 11 if it is not desired to overload the low-pressure turbine 8. The formula (1) presented below thus makes it possible to obtain a compromise between a high rotation speed of the low-pressure shaft 11, and therefore efficient low-pressure turbine 8 and low-pressure compressor 4, and acceptable mechanical integration and loading constraints of the low-pressure turbine 8.

Thus, and as is apparent from the formula (1), when the inlet section Sₑ of the low-pressure turbine 8 is high, the rotation speed of the low-pressure shaft 11 is reduced, and therefore less efficient. This also generates connection issues between the low-pressure turbine 8 and the high-pressure turbine 7 and therefore pressure losses which further reduce the efficiency of the low-pressure turbine 8. In addition, since the low-pressure turbine 8 is bulky, the propulsion system 1 is more difficult to integrate under the wing of an aircraft 100. It is indeed necessary to ensure a flow between the wing and the nacelle of the primary body 3. However, when the low-pressure turbine 8 is very bulky, it becomes necessary to move the propulsion system 1 axially forward relative to the wing in order to maintain this flow, which increases the moment applied by the propulsion system 1 on its fixing to the aircraft 100 (pylon) and creates flutter phenomena.

Preferably,

$${N}_{1} \geq \sqrt{\frac{10}{{S}_{e}}} * 1 {0}^{3}$$

to ensure the integration of the propulsion system 1 under the wing.

Conversely, when the inlet section Sₑ of the low-pressure turbine 8 is reduced, the rotation speed of the low-pressure shaft 11 is very high. The low-pressure turbine 8 and the low-pressure compressor 4 are of course more efficient. However, this gain in efficiency is obtained at the expense, on the one hand of the mechanical strength of the attachment of the blades of the low-pressure turbine 8 to the rotor disk 8b depending on the number of blades, and on the other hand of the feasibility of the low-pressure turbine 8. The mechanical load becomes indeed too high at the attachment of the disk of the low-pressure turbine 8 on the low-pressure shaft 11. In addition, since the inlet section Sₑ is small, the average radius of the low-pressure turbine 8 is necessarily reduced, which reduces the space available under the low-pressure turbine 8. The integration of the bearings and of the corresponding enclosure(s) under the low-pressure turbine 8 then becomes critical.

Thus, in order to guarantee the mechanical strength and feasibility of the low-pressure turbine 8, the propulsion system 1 can also be configured so that the drive speed of the low-pressure turbine 8 also complies with the following formula:

$${N}_{1} \leq \sqrt{\frac{55}{{S}_{e}}} \times {10}^{3}$$

given that 55 is expressed in

$${( \frac{rev}{min} )}^{2} \times {m}^{2}$$

and that the redline speed of the low-pressure shaft 11, which corresponds to the absolute maximum speed likely to be encountered by the low-pressure shaft 11 during the entire flight (according to the European certification regulation EASA CS-E 740 (or according to the American certification regulation 14-CFR Part 33.87), is comprised between 8,500 rpm and 12,000 rpm, preferably between 9,000 rpm and 11,000 rpm. The redline speed corresponds to the maximum rotation speed when the propulsion system is sound (and potentially at the end of its life). It is therefore likely to be reached by the low-pressure shaft 11 in flight conditions. This redline speed forms part of the data declared in the engine certification (type certificate data sheet). Indeed, this rotation speed is usually used as a reference speed for the dimensioning of the propulsion systems 1 and in some certification tests (such as blade loss or rotor integrity tests).

Low-pressure turbines 8 complying with the formula (1) can then have a hub-to-tip ratio at the inlet, which corresponds to the ratio between the outer radius R1 of the low-pressure turbine 7 and the outer radius of the hub R2 of the low-pressure turbine 8 at the inlet of the low-pressure turbine, greater than 0.75 and less than 0.90. The outer radius R1 of the low-pressure turbine 8 and the outer radius R3 of the hub of the low-pressure turbine 8 are measured here in a plane normal to the longitudinal axis X passing through the intersection between the leading edge 8c and the tip 8d of the blades of the most upstream rotor of the low-pressure turbine 8 (that is to say of the first stage of the low-pressure turbine 8). The outer radius R1 of the low-pressure turbine 8 corresponds to the distance, in this plane, between the tip 8b of the rotor blades of the low-pressure turbine 8 and the axis of rotation X of the low-pressure turbine 8. The outer radius of the hub R2 corresponds to the distance, in this same plane, between the outer radial surface of the hub (which radially delimits on the inside the flow path in the low-pressure turbine 8) and the axis of rotation X of the low-pressure turbine 8. As indicated previously, these radii R1, R2 are measured when the propulsion system 1 is cold.

A low-pressure turbine 8 complying with the formula (1) and whose hub-to-tip ratio at the inlet is strictly greater than 0.75 facilitates the integration of the bearings of the low-pressure shaft 11.

Low-pressure turbines 8 complying with the formula (1) may also have a hub-to-tip ratio at the outlet which corresponds to the ratio between the outer radius R1′ of the low-pressure turbine 8 and the outer radius of the hub R2′ of the low-pressure turbine 8 at the outlet of the low-pressure turbine, greater than 0.55 and less than 0.75. The outer radius R1 of the low-pressure turbine 8 and the outer radius R3 of the hub of the low-pressure turbine 8 are measured here in a plane normal to the longitudinal axis X passing through the intersection between the leading edge 8c and the tip 8d of the blades of the rotor furthest downstream of the low-pressure turbine 8 (that is to say of the last stage of the low-pressure turbine 8. The outer radius R1′ of the low-pressure turbine 8 corresponds to the distance, in this plane, between the tip 8b of the blades of the rotor of the low-pressure turbine 8 and the axis of rotation X of the low-pressure turbine 8, when the propulsion system 1 is at rest. The outer radius of the hub R2′ corresponds to the distance, in this same plane, between the outer radial surface of the hub (which radially delimits on the inside the flow path in the low-pressure turbine 8) and the axis of rotation X of the low-pressure turbine 8 when the propulsion system 1 is at rest.

Such low-pressure turbines 8 then have optimized inlet section and outlet section. Indeed, the smaller the hub-to-tip ratio at the inlet and at the outlet, the smaller the outer diameter of the low-pressure turbine 8 (for the same section). A hub-to-tip ratio at the inlet and at the outlet comprised in the intervals described above, thus makes it possible to optimize the low-pressure turbine 8, and in particular its rotation speed N₁ (which is adapted to the inlet Sₑ and outlet sections which expand the gases at the outlet of the combustion chamber 5), in a suitable footprint. The dimensioning of the low-pressure turbine 8 so as to obtain hub-tip ratios comprised in these intervals therefore makes the low-pressure turbine 8 more efficient, and thus reduces the specific consumption of the propulsion system 1, without penalizing its mechanical or thermal load of the flow-pressure turbine 8.

The low-pressure turbines 8 complying with the formula (1) and whose rotation speed N₁ remains less than or equal to

$$\sqrt{\frac{55}{{S}_{e}}} \times 1 {0}^{3}$$

can also be made from conventional materials, such as one at least of the following materials: a nickel-base alloy with directed solidification such as a DS200+Hf alloy, a nickel-base alloy without directed solidification such as a Rene77 alloy, a nickel-base alloy with a monocrystalline structure such as a first-generation superalloy (AM1), an intermetallic alloy such as a TiAl alloy obtained by casting, additive manufacturing or forged.

A propulsion system 1 complying with the formula (1) may comprise a two-spool propulsion system whose low-pressure turbine 8 comprises at least three stages and at most five stages and the low-pressure compressor 4 comprises at least two stages and at most four stages. The high-pressure turbine 7 may then be a two-stage turbine and the high-pressure compressor 5 may comprise at least eight stages and at most eleven stages.

In order to obtain a rotation speed N₁ in accordance with the formula (1), the reduction ratio of the reduction mechanism 19 is greater than or equal to 2.5 and less than or equal to 11. In the case of a propulsion system 1 comprising a ducted fan rotor 9, the reduction ratio may be greater than or equal to 2.7 and less than or equal to 6.0, typically around 3.0. In the case of a propulsion system 1 comprising an unducted fan rotor, the reduction ratio may be comprised between 9.0 and 11.0.

The propulsion system 2 further has an overall compression ratio, which corresponds to the pressure ratio between the outlet pressure of the high-pressure compressor 5 and the inlet pressure of the fan rotor 9 (measured at the root of the fan rotor 9), can be greater than or equal to 40 and less than or equal to 70, preferably greater than or equal to 44 and less than or equal to 55.

In order to optimize the performance of the propulsion system 1 in terms of specific consumption, mass and drag, while ensuring the possibility of integrating the propulsion system 1 into an aircraft 100, the thrust density per blade 14 of the fan rotor 9 is greater than or equal to 5.0×10⁴ and less than or equal to 17.0×10⁴ N/m² where the thrust density per blade 14 is defined by the following formula:

$$Thrust density = \frac{F N}{n * {D}^{2}} * 100$$

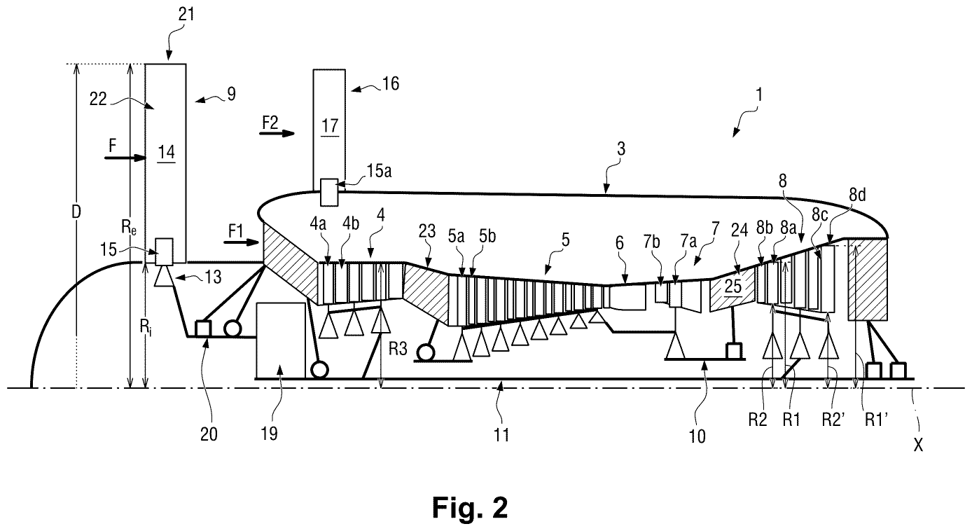

and where:
FN is the thrust generated by the fan rotor 9 and is expressed in Newton (N);
n is the number of blades 14 in the fan rotor 9; and
D is the diameter of the fan rotor 9, measured in a plane normal to the axis of rotation X at an intersection between a tip 21 and a leading edge 22 of the blades 14 of the fan rotor 9, and is expressed in meters (m). It should be noted that since FIGS. 1 and 2 are partial views, the diameter D is only partially visible.

When the propulsion system 1 comprises a ducted fan, the thrust density per blade of the fan rotor 9 is preferably greater than or equal to 14.0×10⁴ N/m² and less than or equal to 17.0×10⁴ N/m². When the propulsion system 1 comprises an unducted fan, the thrust density per blade of the fan rotor 9 is preferably greater than or equal to 5.0×10⁴ N/m² and less than or equal to 10.0×10⁴ N/m².

Indeed, the Applicant found that, when the thrust density is less than 5.0×10⁴ N/m², it is difficult to integrate the propulsion system 1 because it is too bulky, has too significant mass and generates excessive drag. Moreover, when the thrust density is greater than 17.0×10⁴ N/m², the performance of the propulsion system 1 in terms of specific consumption is degraded. The dimensioning of the propulsion system 1 so that the thrust density per blade 14 of the fan rotor 9 is comprised between 14.0×10⁴ and 17.0×10⁴ N/m² in the case of a ducted fan and between 5.0×10⁴ and 10.0×10⁴ N/m² in the case of an unducted fan therefore makes it possible to obtain a compromise between the integration and the performance of the propulsion system 1 when the propulsion system 1 comprises a reduction mechanism 19 and has a high bypass ratio. Such a thrust density interval per blade 14 is further compatible with a fan pressure ratio less than 1.45, which makes it possible to optimize the propulsive efficiency of the propulsion system 1.

By way of example, a propulsion system 1 in accordance with the invention comprising a ducted fan rotor and whose thrust density per fan blade 14 is equal to 15×10⁴ N/m² has a specific consumption lower than 5% compared to the same propulsion system whose thrust density per fan blade is equal to 21×10⁴ N/m². The thrust density per blade of the propulsion system 1 is influenced to the first order by the diameter D of the fan rotor and the pressure ratio of the fan section 2. The bypass ratio (at a defined diameter D), the overall compression ratio and the number of stages in the compression and turbine sections generally have little or no impact on the thrust density per blade 14.

Thus, the dimensioning and manufacturing of the propulsion system 1 comprising a ducted fan so as to obtain a thrust density per blade 14 comprised between 14.0×10⁴ N/m² and 17.0×10⁴ N/m² can be made by first fixing the thrust (FN) to be generated with the fan section 2 and by modifying the diameter (D) of the fan rotor (and therefore the pressure ratio of the fan section 2). Compared to a propulsion system with a conventional reduction mechanism, the diameter D can for example be increased and the fan pressure ratio 2 can be reduced. The number of fan blades 14 (n) and the rotation speed of the fan rotor 9 can also be adapted in order to comply with performance, acoustic and integration requirements. Depending on the aerodynamic characteristics of the fan section 2, the propulsion system 1 can be modified so as to integrate a pitch change mechanism 15, 15a making it possible to adapt the setting of the blades 14 of the rotor 9 (and possibly the vanes 16 of the stator 17) of the fan section 2. Finally, the thermodynamic cycle is adapted to the various parameters thus dimensioned (fan diameter, number of blades, pressure ratio of the fan section 2, etc.) of the propulsion system 1: particularly the flow rate of the gas generator can be reduced and the reduction ratio of the reduction mechanism 19 can be increased.

In the case of an unducted fan, the dimensioning and manufacturing of the propulsion system 1 so as to obtain a thrust density per blade 14 comprised between 5.00×10⁴ N/m² and 10.0×10⁴ N/m² can be achieved by first fixing the thrust (FN) to be generated with the fan section 2 and by modifying the diameter (D) of the fan rotor (and therefore the pressure ratio of the fan section 2) in order to obtain such a thrust. Compared to a propulsion system with a conventional unducted fan and reduction mechanism, the diameter D can for example be slightly reduced to allow the integration of the under-wing propulsion system, and the pressure ratio of the fan 2 can be adapted accordingly to obtain the desired thrust. In a similar manner to the ducted propulsion system, the number of fan blades 14 (n) and the rotation speed of the fan rotor 9 can then be adapted in order to meet performance, acoustic and integration requirements. Depending on the aerodynamic characteristics of the fan section 2, the propulsion system 1 can be modified so as to integrate a pitch change mechanism 15, 15a making it possible to adapt the setting of the blades 14 of the rotor 9 (and possibly the vanes 16 of the stator 17) of the fan section 2. Moreover, depending on the integrated performance balance (fuel consumption balance of the propulsion system 1 integrated in the aircraft (mass, specific consumption, drag)) and the aircraft constraints (in terms of integration and program constraints), the fan section 2 can comprise a single fan rotor 9 or two counter-rotating fan rotors 9. Finally, the thermodynamic cycle is adapted to the various parameters thus dimensioned (fan diameter, number of blades, pressure ratio of the fan section 2, overall compression ratio, etc.) of the propulsion system 1: particularly, the flow rate of the gas generator can be reduced and the reduction ratio of the reduction mechanism 19 can be increased.

For thrust densities per blade 14 comprised between 5.0×10⁴ and 17.0×10⁴ N/m², the diameter D of the fan rotor can then be comprised between 80 inches (203.2 cm) and 185 inches (469.9 cm) inclusive. When the fan rotor 9 is ducted, the diameter D is preferably comprised between 85 inches (215.9 cm) and 120 inches (304.8 cm) inclusive, for example of the order of 90 inches (228.6 cm), which makes it possible to integrate the propulsion system 1 in a conventional manner, particularly under the wing of an aircraft. When the fan rotor 9 is unducted, the diameter D is preferably greater than or equal to 100 inches (254 cm), for example between 120 inches (304.8 cm) and 156 inches (396.2 cm).

The fan rotor 9 moreover comprises at least twelve blades 14 and at most twenty-four blades 14, preferably at least sixteen blades 14 and at most twenty-two blades 14. The number of vanes 16 in the fan stator 17 depends on the acoustic criteria defined for the propulsion system 1 and is at least equal to the number of blades 14.

In order to further improve the propulsive efficiency of the propulsion system 1, the power density per blade 14 of the fan rotor 9 is greater than or equal to 3.65×10⁶ and less than or equal to 22.0×10⁶ W/m², where the power density per blade 14 of the fan rotor 9 is defined by the following formula:

$$Power density = \frac{power of the fan}{n * {D}^{2}} * 100$$

where the power of the fan corresponds to the power of the fan rotor 9 and is expressed in Watts (W).

In the case of a propulsion system 1 comprising a ducted fan section 2, the power density per fan blade is preferably greater than or equal to 16.0×10⁶ and less than or equal to 22.0×10⁶ W/m².

In the case of a propulsion system 1 comprising an unducted fan section 2, the power density per fan blade is preferably greater than or equal to 3.65×10⁶ and less than or equal to 7.50×10⁶ W/m².

The fan rotor 9 also has a hub-to-tip ratio comprised between 0.22 and 0.32. In the case of a fixed-setting fan rotor, the hub-to-tip ratio may be comprised between 0.24 and 0.32. In the case of a fixed-setting fan rotor, the hub-to-tip ratio is preferably comprised between 0.26 and 0.32 in order to allow the integration of the pitch change mechanism 15. The hub-to-tip ratio corresponds to the ratio between the inner radius Rᵢ and the outer radius Re of the fan rotor 9. The inner radius Rᵢ corresponds to the distance between the axis of rotation X and the point of intersection between the leading edge 22 and the surface which radially delimits on the inside the flow path at the inlet of the fan rotor 9 (and corresponds to the point of connection of the leading edge 22 with the aerodynamic surface of a platform of the fan rotor 9). The outer radius Re corresponds to the distance between the axis of rotation X and the point of intersection between the leading edge 22 and the tip 21 of the fan blades (and corresponds to half the fan diameter D). The lower the hub-to-tip ratio, the more efficient the fan rotor 9. However, the reduction of the hub-to-tip ratio of the fan rotor 9 implies an increase in the mechanical load of the hub 13 of the fan rotor 9. The dimensioning of the fan rotor 9 such that its hub-to-tip ratio is comprised between 0.22 and 0.32 particularly makes it possible to obtain a thrust density and a power density per blade 14 within the intervals defined above.

### Comparative Examples

(a) Propulsion Systems with Ducted Fan:

Engine 1 is a two-spool propulsion system corresponding to the current technical standard (on the filing date of the present application) sought to be improved which comprises a ducted fan section.

Engine 2 is a two-spool propulsion system 1 conforming to the teaching of the present application which comprises a ducted fan.

| | | | Engine 2 | |
|---|---|---|---|---|
| | Engine 1 | | (consistent with the | |
| Dimensioning parameter (SLS unless | (ducted reference | | disclosure of the | |
| otherwise specified) | engine) | | present application) | |
| Inlet temperature of the low-pressure turbine 8 | 1,027 ° C. | | 1,032 ° C. | |
| (Tₑ) | | | | |
| Outer radius at the inlet of the low-pressure | 383.1 | mm | 399.8 | mm |
| turbine 8 | | | | |
| inner radius at the inlet of the low-pressure | 248.5 | mm | 271.28 | mm |
| turbine 8 | | | | |
| Inlet section (Se) | 0.267 | m² | 0.271 | m² |
| Redline speed of the low-pressure shaft 11 | 8 962.42 | rpm | 10 043 | rpm |
| (N₁) | | | | |
| $\sqrt{\frac{α * {T}_{e} + β}{S e}} \times {10}^{3}$ | 9 833 | rpm | 9,705 | rpm |
| Hub-to-tip ratio of the low-pressure turbine 8 | 0.65 | | 0.68 | |
| (at the inlet) | | | | |
| Hub-to-tip ratio of the low-pressure turbine 8 | 0.53 | | 0.57 | |
| (at the outlet) | | | | |
| Overall compression ratio | 42 | | 50 | |
| Reduction ratio | 2.73 | | 3.53 | |
| Number of stages of the low-pressure | 2 | | 2 | |
| compressor 4 | | | | |
| Number of high-pressure compressor stages 5 | 10 | | 10 | |
| Number of high-pressure turbine stages 7 | 2 | | 2 | |
| Number of low-pressure turbine stages 8 | 4 | | 3 | |
| Inlet temperature of the high-pressure turbine | 1,577 ° C. | | 1,627 ° C. | |
| 7 | | | | |
| N₁²S | 36.75 × 10⁶ | | 48.62 × 10⁶ | |
| (where S is the outlet section of the low- | (rpm)² · m² | | (rpm)² · m² | |
| pressure turbine 8) | | | | |
| Thrust of the fan FN | 158 801.5 N (35 700 | | 156 527 N (35 200 lbf) | |
| | klbf) | | | |
| Diameter D | 2.11 m (83 in.) | | 2.413 m (95 in.) | |
| Number of blades n | 18 | | 18 | |
| Thrust density per fan blade | 1.98 × 10⁵ | N/m² | 1.50 × 10⁵ | N/m² |
| Power of the fan | 21 297 798 | W | 20 889 407 | W |
| Pressure ratio of the fan | 1.43 | | 1.37 | |
| Power density per fan blade | 2.66 × 10⁷ | W/m² | 1.99 × 10⁷ | W/m² |
| Bypass ratio BPR | 11.0 | | 12.0 | |
| Peripheral speed of the blades 14 | 346 | m/s | 343 | m/s |
| Hub-to-tip ratio of the fan | 0.30 | | 0.3 | |
| Redline speed of the fan rotor 9 | 3 284 | rpm | 2,842 | rpm |
| Redline speed of the high-pressure shaft 10 | 19 888 | rpm | 19 741 | rpm |

| | | |
|---|---|---|
| Compression ratio of low-pressure compressor | 1.85 | 1.85 |

The redline speed N₁ of the low-pressure shaft of the engine 1 does not comply with the claimed formula since it is less than 9 833 rpm. Conversely, the redline speed N₁ of the low-pressure shaft 11 of the engine 2 does comply with the claimed formula. It appears that the engine 2 has a better specific consumption than the engine 1, without the need to significantly increase the inlet temperature of the low-pressure turbine. The efficiency of fan section 2 has therefore been improved without requiring additional thermal loading of the low-pressure turbine and without modifying the number of stages in the low-pressure compressor.

Similarly, the thrust density per fan blade of the engine 1 is greater than 1.70×10⁵ N/m², while the engine 2 has a thrust density per fan blade comprised between 1.40 and 1.70×10⁵ N/m². The engine 2 therefore has lower specific consumption than the engine 1.

To move from the (reference) engine 1 to the engine 2 (consistent with the disclosure), the overall compression ratio was increased as well as the inlet temperature of the high-pressure turbine 7, which made it possible to increase the thermal efficiency of the propulsion system 1. In addition, the fan diameter D and the bypass ratio BPR were increased, which made it possible to improve the propulsive efficiency and to maintain comparable thrust given the drop in the pressure ratio of the fan 2. Finally, insofar as the temperature of low-pressure turbine 8 was kept stable, it was possible to increase its mechanical loading (N₁²S) and therefore reduce its number of stages.

(b) Propulsion Systems with Unducted Fan:

Engine 3 is a two-spool propulsion system corresponding to the current technical standard (at the filing date of the present application) sought to be improved which comprises an unducted fan section.

Engine 4 is a two-spool propulsion system 1 conforming to the teaching of the present application which comprises an unducted fan section.

| | | | Engine 4 | |
|---|---|---|---|---|
| | Engine 3 | | (consistent with the | |
| Dimensioning parameter (SLS unless | (unducted | | disclosure of the | |
| otherwise specified) | reference engine) | | present application) | |
| Inlet temperature of the low-pressure turbine 8 | 1,029 ° C. | | 1,027 ° C. | |
| (Tₑ) | | | | |
| Outer radius at the inlet of the low-pressure | 378.1 | mm | 371.7 | mm |
| turbine 8 | | | | |
| inner radius at the inlet of the low-pressure | 284.0 | mm | 277.4 | mm |
| turbine 8 | | | | |
| Inlet section (Se) | 0.196 | m² | 0.192 | m² |
| Redline speed of the low-pressure shaft 11 | 9 360.4 | rpm | 11 616.3 | rpm |
| (N₁) | | | | |
| $\sqrt{\frac{α * {T}_{e} + β}{S e}} \times {10}^{3}$ | 11 53.73 | rpm | 11 584 | rpm |

| Hub-to-tip ratio of the low-pressure turbine 8 | 0.75 | | 0.75 | |
|---|---|---|---|---|
| (at the inlet) | | | | |
| Hub-to-tip ratio of the low-pressure turbine 8 | 0.65 | | 0.64 | |
| (at the outlet) | | | | |
| Overall compression ratio | 42 | | 50 | |
| Reduction ratio | 10.56 | | 10.60 | |
| Number of stages of the low-pressure | 2 | | 2 | |
| compressor 4 | | | | |
| Number of high-pressure compressor stages 5 | 10 | | 10 | |
| Number of high-pressure turbine stages 7 | 2 | | 2 | |
| Number of low-pressure turbine stages 8 | 4 | | 3 | |
| Inlet temperature of the high-pressure turbine | 1,527 ° C. | | 1,577 ° C. | |
| 7 | | | | |
| N₁²S | 30.57 × 10⁶ | | 45.6 ×10⁶ | |
| (where S is the outlet section of the low- | (rpm)² · m² | | (rpm)² · m² | |
| pressure turbine 8) | | | | |
| Thrust of the fan FN | 125 482 | N | 129 558 | N |
| | (28 211 lbf) | | (29 127 lbf) | |
| Diameter D | 4.699 m (185 in.) | | 4.064 m (160 in.) | |
| Number of blades n | 12 | | 12 | |
| Thrust density per blade | 4.74 × 104 | N/m² | 6.54 × 104 | N/m² |
| Power of the fan | 10 324 395 | W | 11 792 949 | W |
| Pressure ratio of the fan | 1.055 | | 1.075 | |
| Power density per blade | 3.90 × 10⁶ | W/m² | 5.95 × 10⁶ | W/m² |
| Bypass ratio BPR | 50.0 | | 40.0 | |
| Peripheral speed of the blades 14 | 193.95 | m/s | 207.28 | m/s |
| Hub-to-tip ratio | 0.25 | | 0.25 | |
| Redline speed of the fan rotor 9 | 887 | rpm | 1,096 | rpm |
| Redline speed of the high-pressure shaft 10 | 21 400 | rpm | 23,453 | rpm |

| | | |
|---|---|---|
| Compression ratio of low-pressure compressor | 1.85 | 1.85 |

The redline speed N₁ of the low-pressure shaft of the engine 3 does not comply with the claimed formula since it is less than 11 453.73 rpm. Conversely, the redline speed N₁ of the low-pressure shaft 11 of the engine 4 complies with the claimed formula. It appears that the engine 4 has a better compactness than the engine 3, without the need to increase the inlet temperature of the low-pressure turbine.

Similarly, the thrust density per fan blade of the engine 3 is less than 5.0×10⁴ N/m², while the engine 4 has a thrust density per fan blade comprised between 5.0 and 10.0×10⁴ N/m². The engine 4 therefore has a greater compactness than the engine 3.

To move from the (reference) engine 3 to the engine 4 (consistent with the disclosure), the overall compression ratio was increased as was the inlet temperature of the high-pressure turbine 7, which made it possible to increase the thermal efficiency of the propulsion system 1. The fan diameter D and the bypass ratio BPR were reduced, which made it possible to improve the integration of the engine 2. The compression ratio of the fan of the engine 2 was however slightly increased (while remaining below 1.45) to maintain equivalent thrust. Finally, insofar as the temperature of the low-pressure turbine 8 was kept stable, it was possible to increase its mechanical loading (N₁²S) and therefore reduce its number of stages.

Insofar as the fan section represents most of the mass of an unducted propulsion system 1, its greater compactness allows mass reduction and easier installation on the aircraft. These elements allow the aircraft comprising an engine 4 to have lower fuel consumption.

1. A propulsion system comprising:
a drive turbine connected to a drive shaft movable in rotation about an axis of rotation;
a fan section comprising a fan rotor connected to a fan shaft; and
a reduction structure coupling the drive shaft and the fan shaft in order to drive the fan shaft at a rotation speed lower than the rotation speed of the drive shaft;
wherein the propulsion system is configured so that a rotation speed of the drive shaft complies with the following formula:
$${N}_{1} \geq \sqrt{\frac{α * {T}_{e} + β}{S e}} \times 1 {0}^{3}$$
where:
N₁ is a rotation speed of the drive shaft when the propulsion system is stationary in take-off rating in a standard atmosphere and at sea level and is expressed in revolutions per minute;
Tₑ is an inlet temperature of the drive turbine when the propulsion system is stationary in take-off rating in a standard atmosphere and at sea level and is expressed in degrees Celsius and is greater than or equal to 700° C.;
Sₑ is an inlet section of the drive turbine, in square meters; and
$$α = - 0.056 {( \frac{r e v}{min} )}^{2} \times \frac{{m}^{2}}{° C .} and β = 83.356 {( \frac{r e v}{min} \times m )}^{2} .$$

2. The propulsion system according to claim 1, wherein the propulsion system is further configured so that the rotation speed of the drive turbine also complies with the following formula:
$${N}_{1} \leq \sqrt{\frac{55}{{S}_{e}}} \times {10}^{3} .$$

3. The propulsion system according to claim 1, wherein the reduction structure has a reduction ratio greater than or equal to 2.5.

4. The propulsion system according to claim 1, wherein the drive turbine comprises at least three stages and at most five stages.

5. The propulsion system according to claim 1, wherein the drive turbine has a hub-to-tip ratio at the inlet greater than 0.75 and less than 0.90.

6. The propulsion system according to claim 1, wherein the drive turbine has a hub-to-tip ratio at the outlet greater than 0.55 and less than 0.75.

7. The propulsion system according to claim 1, further comprising a compressor directly connected to the drive turbine by the drive shaft so that a rotation speed of the compressor is equal to the rotation speed of the drive shaft, the compressor comprising at least two stages and at most four stages.

8. The propulsion system according to claim 1, further comprising a second turbine and a second compressor connected via a second shaft, the second shaft rotating faster than the drive shaft, the second turbine being a two-stage turbine.

9. The propulsion system according to claim 8, wherein the second compressor comprises at least eight stages and at most eleven stages.

10. The propulsion system according to claim 1, wherein a thrust density per blade of the fan rotor of the propulsion system is greater than or equal to 5.0×10⁴ and less than or equal to 17.0×10⁴ N/m² where the thrust density per blade is defined by the following formula:
$$Thrust density = \frac{F N}{n * {D}^{2}} * 100$$
and where: FN is the thrust generated by the fan rotor and is measured when the propulsion system is stationary in take-off rating in a standard atmosphere and at sea level and is expressed in Newton;
n is the number of blades in the fan rotor; and
D is the diameter of the fan rotor, measured in a plane normal to the axis of rotation at an intersection between a tip and a leading edge of the blades of the fan rotor, and is expressed in meters.

11. The propulsion system according to claim 1, wherein a power density per blade of the fan rotor is greater than or equal to 3.65×10⁶ and less than or equal to 22.0×10⁶ W/m², wherein the power density per blade of the fan rotor is defined by the following formula:
$$Power density = \frac{power of the fan}{n * {D}^{2}} * 100$$
and where: the power of the fan corresponds to the power of the fan rotor and is measured when the propulsion system is stationary in take-off rating in a standard atmosphere and at sea level and is expressed in Watts;
n is a number of blades in the fan rotor; and
D is a diameter of the fan rotor, measured in a plane normal to the axis of rotation at an intersection between a tip and a leading edge of the blades of the fan rotor, and is expressed in meters.

12. The propulsion system according to claim 1, wherein the fan section further has a fan compression ratio, corresponding to a pressure ratio between an outlet of the fan rotor and an inlet of the fan rotor less than or equal to 1.45.

13. The propulsion system according to claim 1, wherein the diameter of the fan rotor is comprised between 80 inches and 185 inches inclusive.

14. The propulsion system according to claim 1, wherein the fan section is ducted and a bypass ratio of the propulsion system is greater than or equal to 10.

15. The propulsion system according to claim 1, wherein the fan section is ducted and a peripheral speed at the tip of the blades of the fan rotor, when the propulsion system is stationary in take-off rating in a standard atmosphere and at sea level, is comprised between 260 m/s and 400 m/s.

16. The propulsion system according to claim 1, wherein the fan section is ducted and a thrust density per blade of the fan rotor of the propulsion system is greater than or equal to 14.0×10⁴ and less than or equal to 17.0×10⁴ N/m² where the thrust density per blade is defined by the following formula:
$$Thrust density = \frac{F N}{n * {D}^{2}} * 100$$
and where:
FN is the thrust generated by the fan rotor and is measured when the propulsion system is stationary in take-off rating in a standard atmosphere and at sea level and is expressed in Newton;
n is a number of blades in the fan rotor; and
D is a diameter of the fan rotor, measured in a plane normal to the axis of rotation at an intersection between a tip and a leading edge of the blades of the fan rotor, and is expressed in meters.

17. The propulsion system according to claim 1, wherein the fan section is unducted and a bypass ratio of the propulsion system is greater than or equal to 40.

18. The propulsion system according to claim 1, wherein the fan section is unducted and a peripheral speed at the tip of the blades of the fan rotor, when the propulsion system is stationary in take-off rating in a standard atmosphere and at sea level, is comprised between 210 m/s and 260 m/s.

19. The propulsion system according to claim 1, wherein the fan section is unducted and a thrust density per blade of the fan rotor of the propulsion system is greater than or equal to 5.0×10⁴ and less than or equal to 10.0×10⁴ N/m² where the thrust density per blade is defined by the following formula:
$$Thrust density = \frac{F N}{n * {D}^{2}} * 100$$
and where:
FN is the thrust generated by the fan rotor and is measured when the propulsion system is stationary in take-off rating in a standard atmosphere and at sea level and is expressed in Newton;
n is a number of blades in the fan rotor; and
D is a diameter of the fan rotor, measured in a plane normal to the axis of rotation at an intersection between a tip and a leading edge of the blades of the fan rotor, and is expressed in meters.

20. An aircraft comprising at least one propulsion system according to claim 1 fixed to the aircraft via a mast.

21. A method for dimensioning a propulsion system comprising a reduction structure coupling a drive turbine and a fan rotor to drive the fan rotor at a speed lower than a speed of the drive turbine, the drive turbine configured so that a rotation speed of the drive shaft complies with the following formula:
$${N}_{1} \geq \sqrt{\frac{α * {T}_{e} + β}{S e}} \times 1 {0}^{3}$$
where:
N₁ is the rotation speed of the drive shaft when the propulsion system is stationary in take-off rating in a standard atmosphere and at sea level and is expressed in revolutions per minute;
Tₑ is an inlet temperature of the drive turbine when the propulsion system is stationary in take-off rating in a standard atmosphere and at sea level and is expressed in degrees Celsius and is greater than or equal to 700° C.;
Sₑ is an inlet section of the drive turbine, in square meters; and
$$α = - 0.056 {( \frac{r e v}{min} )}^{2} \times \frac{{m}^{2}}{° C .} and β = 83.356 {( \frac{r e v}{min} \times m )}^{2} .$$

22. A dimensioning method according to claim 21, wherein the fan section is dimensioned such that a thrust density per blade of the fan rotor of the propulsion system is greater than or equal to 5.0×10⁴ and less than or equal to 17.0×10⁴ N/m² where the thrust density per blade is defined by the following formula:
$$thrust density = \frac{F N}{n * {D}^{2}} * 100$$
and where:
FN is the thrust generated by the fan rotor and is measured when the propulsion system is stationary in take-off rating in a standard atmosphere and at sea level and is expressed in Newton;
n is a number of blades in the fan rotor; and
D is a diameter of the fan rotor, measured in a plane normal to the axis of rotation at an intersection between a tip and a leading edge of the blades of the fan rotor, and is expressed in meters.

23. The dimensioning method according to claim 21, wherein the fan is further dimensioned such that a power density per blade of the fan rotor is greater than or equal to 3.65×10⁶ and less than or equal to 22.0×10⁶ W/m², where the power density per blade of the fan rotor is defined by the following formula:
$$Power density = \frac{power of the fan}{n * {D}^{2}} * 100$$
and where: the power of the fan corresponds to the power of the fan rotor and is measured when the propulsion system is stationary in take-off rating in a standard atmosphere and at sea level and is expressed in Watts;
n is a number of blades in the fan rotor; and
D is a diameter of the fan rotor, measured in a plane normal to the axis of rotation at an intersection between a tip and a leading edge of the blades of the fan rotor, and is expressed in meters.

24. The method for manufacturing a propulsion system comprising:
dimensioning the propulsion system according to claim 21; and
manufacturing the propulsion system.
